(19) United States
(12) Patent Application Publication
(10) Pub. No.: US 2008/0066006 A1
(43) Pub. Date: Mar. 13, 2008

(54) Method and system for displaying application windows for computer system using video data modulation

(75) Inventor: Hyun-Seok Kim, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/729,941

(22) Filed: Mar. 30, 2007

(30) Foreign Application Priority Data
Sep. 11, 2006 (KR) 2006-87302

(51) Int. Cl. G06F 3/048

(52) U.S. Cl. 715/781

(57) ABSTRACT

A method and system for displaying application windows are provided to facilitate multitasking by effectively managing multiple open application windows. The method for displaying application windows on a display screen that is divided into an active part and a non-active part includes modulating video data corresponding to the non-active part using auxiliary data and displaying the modulated video data in the non-active part on the display screen. The application window display method of the present invention facilitates the modulation of video data for unimportant image objects such as non-active application windows and a desktop image such that only important image objects such as an active application window and other preset objects are prominently displayed. This allows a user to focus their attention on a current task.

### PRIORITY

This application claims the benefit under 35 U.S.C. § 119(a) of a Korean Patent Application filed in the Korean Intellectual Property Office on Sep. 11, 2006 and assigned Serial No. 2006-87302, the entire disclosure of which is hereby incorporated by reference.

### BACKGROUND OF THE INVENTION

1. Field of the Invention

The present invention relates to a graphic user interface of a computer system. More particularly, the present invention relates to a method and system for displaying application windows that are capable of facilitating multiple tasks by effectively managing multiple open application windows.

2. Description of the Related Art

A computer system is a combination of hardware providing basic computer resources such as a central processing unit (CPU), memory, input/output devices, and software including an operating system for controlling and coordinating use of the hardware to run other applications.

A windowing system is a graphical user interface. The windowing system provides a desktop window on a display screen as a background and application windows over the desktop window. A typical windowing system allows each application to be open in a window mode or a pull screen mode.

When multiple windows are open, the window of the currently active task becomes a front-most window and the other windows associated with non-active tasks are beneath the front-most window.

However, most of the conventional windowing systems display all the windows associated with the active and non-active tasks and the desktop window simultaneously in an identical display setting and level of brightness. This produces confusing and frustrating circumstances for the user since multiple windows are open. Also, since a desired window may be blocked from view by another, the user may not know how to navigate to the desired window without closing all the overlaying windows. A plurality of open windows may present a cluttered interface even for an experienced user.

To solve the above problems, for example, Korean Patent Laid-Open No. 2002-37098 discloses a method of adjusting brightness of an active monitor-unit and a system that increases amplification of red, green, and blue (RGB) signals for an active application window and decreases amplification of RGB signals for non-active application windows. However, since the conventional method distinguishes the active application window from the non-active application windows only through the brightness of windows, it does not satisfy user's desires for various window display modes and is limited in removing the clutter due to non-active application windows.

Accordingly, there is a need for an improved system and method for improving a user's ability to multitask when a plurality of application windows are open.

### SUMMARY OF THE INVENTION

An aspect of exemplary embodiments of the present invention is to provide at least the advantages described below. Accordingly, an aspect of exemplary embodiments of the present invention is to provide a window-based graphical user interface that can improve user's ability to multitask by using a plurality of open application windows.

It is another object of an exemplary embodiment of the present invention to provide a window-based graphical user interface that can remove clutter caused by open application windows relating to non-active tasks.

In accordance with an aspect of an exemplary embodiment of the present invention, the above and other objects are accomplished by a method and system for displaying application windows on a display screen that is divided into an active part and a non-active part. The method for displaying application windows includes modulating video data corresponding to the non-active part using auxiliary data and displaying the modulated video data in the non-active part on the display screen.

### BRIEF DESCRIPTION OF THE DRAWINGS

The above and other exemplary objects, features and advantages of certain exemplary embodiments of the present invention will be more apparent from the following description taken in conjunction with the accompanying drawings, in which:

FIG. 1 is a block diagram illustrating a configuration of a computer system equipped with an application window display method according to an exemplary embodiment of the present invention;

FIG. 2 is a flowchart illustrating a video data modulation configuration procedure of the application window display method according to an exemplary embodiment of the present invention;

FIG. 3 is a diagram illustrating an example of a configuration box for an application window display method according to an exemplary embodiment of the present invention;

FIG. 4 is a flowchart illustrating an application window display method according to an exemplary embodiment of the present invention;

FIG. 5 is a flowchart illustrating a modulation procedure of the application window display method of FIG. 4;

FIG. 6 is a flowchart illustrating a procedure for setting a modulation range of a non-active application window in the application window display method according to an exemplary embodiment of the present invention; and

FIGS. 7 to 12 are examples of screen images illustrating the application window display method according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

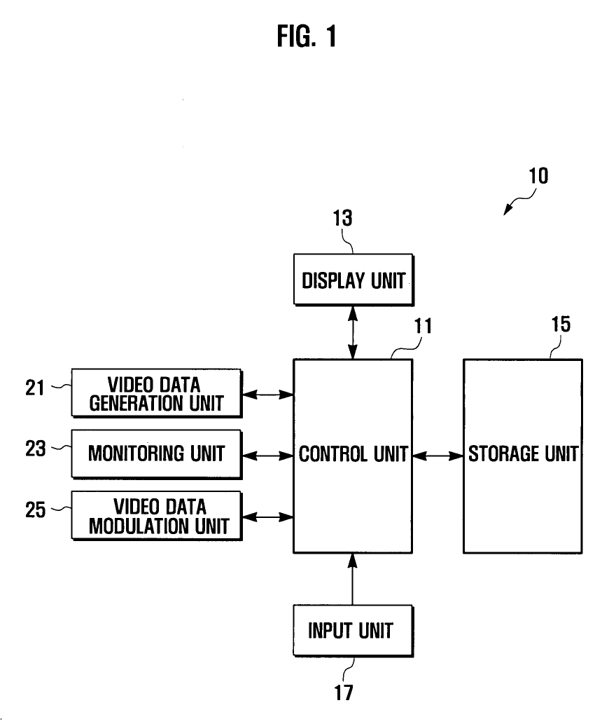

FIG. 1 is a block diagram illustrating a configuration of a computer system equipped with an application window display method according to an exemplary embodiment of the present invention.

Referring to FIG. 1, the computer system 10 includes a control unit 11, a display unit 13, a storage unit 15, an input unit 17, a video data generation unit 21, a monitoring unit 23 and a video data modulation unit 25.

The display unit 13 displays images represented by information on the operation of the computer system 10 on the basis of video signals from the video data generation unit 21. The display unit 13 displays frame images on a screen, for example on the basis of RGB signals. The display unit 13 is implemented with a screen comprising two parts. A first part displays video data with one or more application windows selected by a user, and a second part displays other video data except for the video data displayed on the first part. The second part displays the video data for non-active application windows and background video data. For example, if a region displaying an application window is set to the first part by the user, the remaining region is set to the second part. Multiple application windows can be set to a first part such that the second part is automatically defined as such.

The storage unit 15 stores an operating system for the computer system 10, application programs, and data generated while the application programs are operating. The storage unit 15 also stores configuration parameters related to a modulation of the video data, for example, information on a modulation range, modulation type, and modulation degree, among others for the second part.

The input unit 17 generates command signals for operating the computer system 10 according to the user's manipulation. The input unit 17 includes a keyboard, mouse, touchscreen, touchpad, and keypad, among others.

The monitoring unit 23 monitors signals related to the first and second parts of the screen of the display unit 13 and variations of the signals. The monitoring unit 23 verifies appearances and disappearances of the application window, switching between an active state and non-active state of each application window, changing a size and position of each application window, changing between a foreground state and a background state of each application window, and changing between a window mode and a full screen mode of each application window. The monitoring unit 23 monitors and traces variations of the application windows exploiting unique identification numbers (IDs). The monitoring unit 23 assigns a highest priority ID to the application window selected by the user and displays the application window comprising the highest priority ID on a foreground layer. The monitoring unit 23 also assigns IDs that have different priorities to other application windows on the basis of the order in which the application windows are selected.

The video data generation unit 21 generates video data for the first and second parts of the screen of the display unit 13. The video data generation unit 21 generates the video data in correspondence with the variation of the first and second parts monitored by the monitoring unit 23 under the control of the control unit 11. For example, if a selection of a specific application window is detected by the monitoring unit 23, the video data generation unit 21 processes the selected application window to be a front-most window. Accordingly, the selected application window belongs to the first part of the screen.

The video data modulation unit 25 modulates the video data for the second part using an auxiliary data under the control of the control unit 11. The auxiliary data is mixed with the video data for the second part or replaces the video data for modulating the video data. The modulation of the video data is performed according to a configuration of a video data modulation scheme stored in the storage unit 15. That is, the video data modulation unit 25 modulates the video data for the second part according to the information on the modulation range, modulation type, and modulation degree stored in the storage unit 15.

The control unit 11 controls overall operations of the computer system 10. The control unit 11 can be a central processing unit or a microcomputer. The control unit 11 controls cooperation of the video data generation unit 21, the monitoring unit 23, and the video data modulation unit 25 to modulate the video data displayed on the second part of the screen.

Operation of the above-structured computer system for implementing an application window display method is described hereinafter. First, a procedure for configuring the video data modulation for the second part of the screen is described.

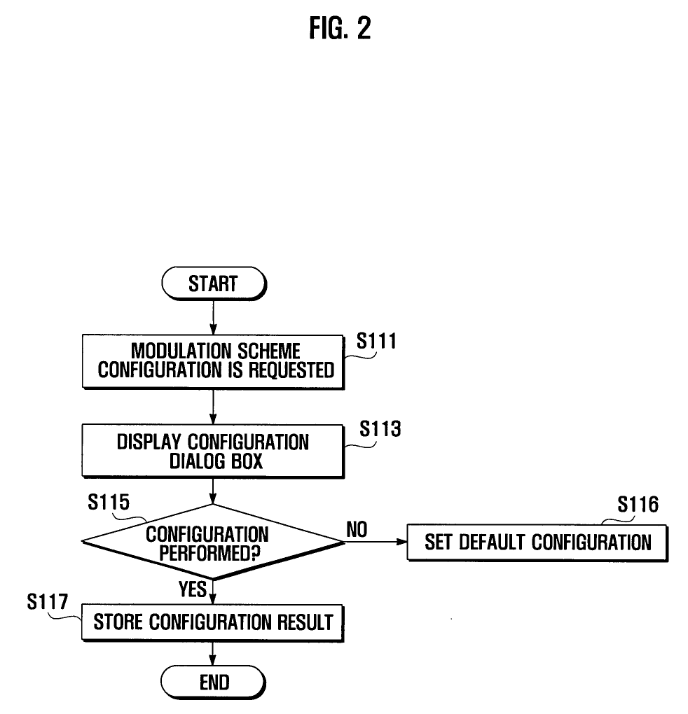

FIG. 2 is a flowchart illustrating a video data modulation configuration procedure of the application window display method according to an exemplary embodiment of the present invention.

Referring to FIG. 2, the control unit 11 determines that a modulation scheme configuration request is input (S111). When a modulation scheme configuration request is input, the control unit 11 displays a configuration dialog box with option items for configuring the video data modulation scheme (S113). While displaying the configuration dialog box, the control unit 11 determines whether a configuration is performed by the user (S115). If a configuration is performed by the user, the control unit 11 stores the configuration result in the storage unit 15 (S117).

The configuration dialog box includes a modulation function activation option item to enable or disable the modulation function, a second part modulation range item for setting the modulation range of the video data, a modulation type item for setting the modulation type of the video data, and a modulation level item for setting the modulation level of the video data. The configuration dialog box can include other option items for configuring the modulation scheme. If there is no configuration by the user, the control unit 11 sets the configuration to a default setting in which the configuration items are set to default values (S116), then stores the configuration result in the storage unit 15 (S117).

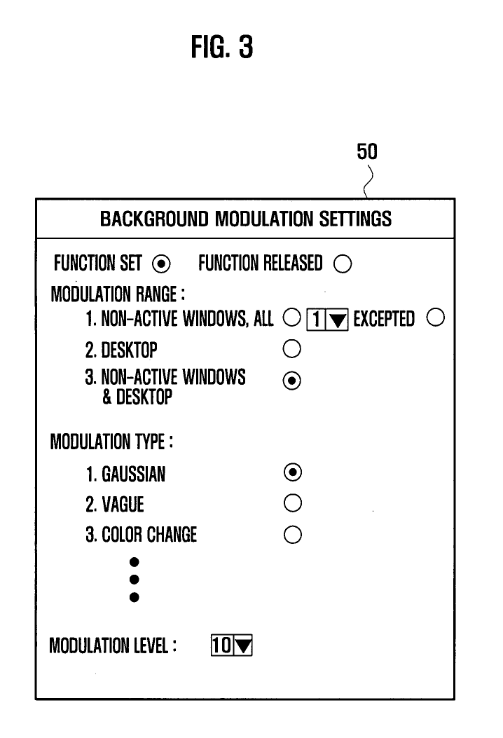

FIG. 3 is a diagram illustrating an example of a configuration dialog box for an application window display method according to an exemplary embodiment of the present invention.

Referring to FIG. 3, a configuration dialog box 50 has a title “background modulation settings.” According to an exemplary implementation, “background” is the second part on the screen.

The configuration dialog box 50 includes a “function activation” item, a “modulation range” item, a “modulation type” item, and a “modulation level” item.

The “modulation range” item includes “non-active application windows,” “desktop,” and “non-active application windows and desktop” options. The selected option of the modulation range item defines the first and second parts on the screen of the display unit 13. The “non-active application windows” option is provided with an additional option for setting an excluded number of non-active application windows. The number of the excluded non-active application windows determines a number of the application windows for the first part on the screen of the display unit 13.

The “modulation type” item includes, but is not limited to, “Gaussian”, “Vague,” and “Color Change” options, among others. The “modulation type” item can include various additional options such as “smudge” and “color selection” options.

The “modulation level” item is provided together with the “modulation type” item such that the modulation level of the selected “modulation type” can be adjusted using the “modulation level” item. For example, if the “Gaussian” modulation type option is selected, the Gaussian modulation level can be adjusted by selecting a modulation level value provided by the “modulation level” option.

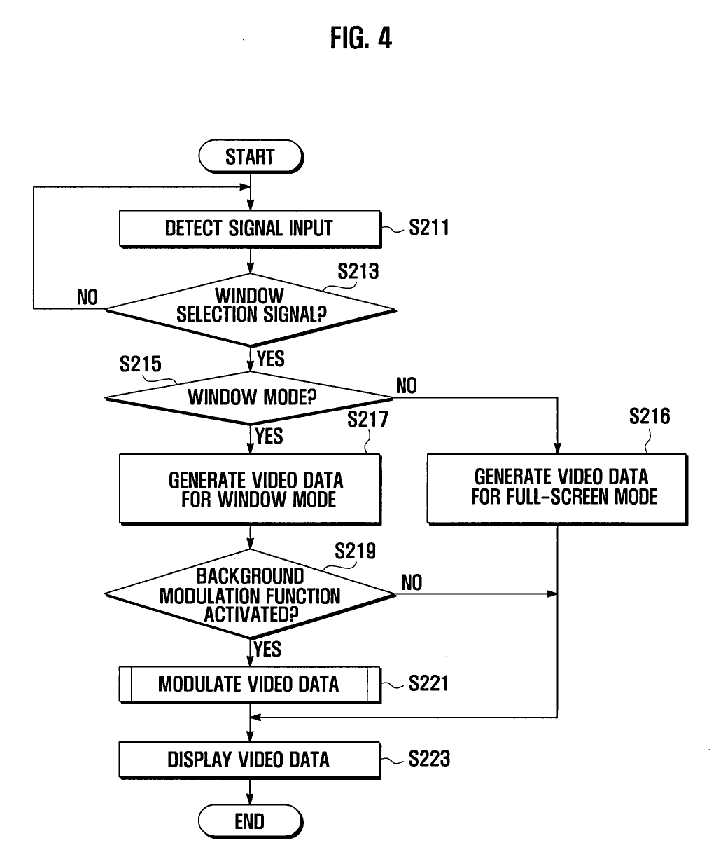

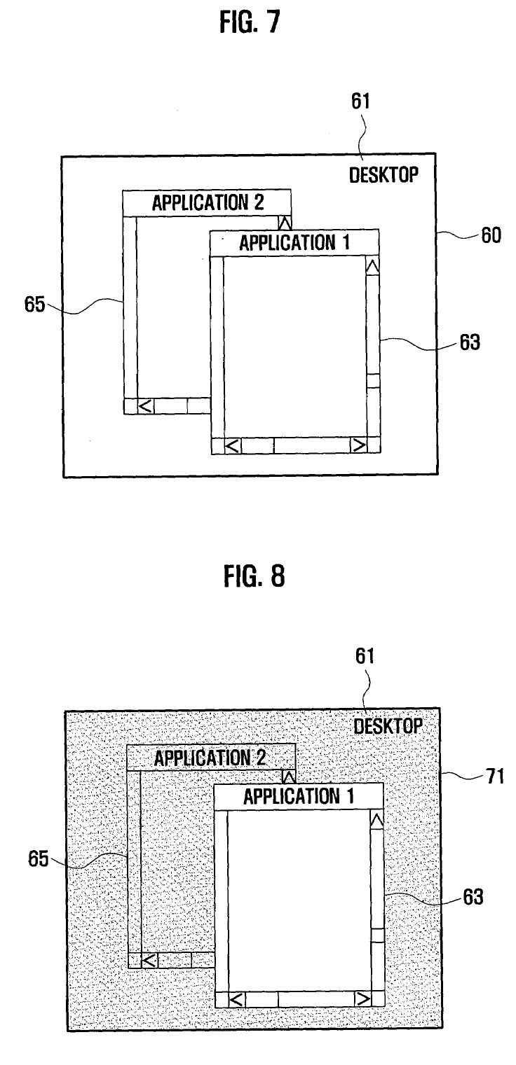

FIGS. 4 to 6 are flowcharts illustrating an application window display method according to an exemplary embodiment of the present invention, FIGS. 7 to 12 are examples of screen images illustrating the application window display method according to an exemplary embodiment of the present invention.

Referring to FIG. 4, the control unit 11 detects a signal input through the input unit 17 (S211). If a signal is input, the control unit 11 determines whether the input signal is a window selection signal for selecting a specific application window (S213). If the input signal is a window selection signal, the control unit 11 determines whether a current view mode is a window mode by exchanging signals with the monitoring unit 23 (S215). If a current view mode is not a window mode, the control unit 11 generates video data for a full-screen mode image (S216) and displays the selected application window in a full-screen mode (S223) on the screen of the display unit 13.

If a current view mode is a window mode at step S215, the control unit 11 generates video data for a foreground window mode image (S217). The control unit 11 then determines whether the background modulation function is activated (S219). If the background modulation function is not activated, the control unit 11 displays the selected application window on the screen without modulation of the window, as illustrated in FIG. 7. Referring to FIG. 7, the screen image 60 includes an active application window 63 and a non-active application window 65.

If the background modulation function is activated, the control unit 11 controls a cooperation of the storage unit 15, monitoring unit 23, and video data modulation unit 25 to modulate the video data to be displayed in the second part on the screen of the display unit 13 (S221). The video data to be displayed at the second part is determined by the information on the modulation range stored in the storage unit 15. That is, the modulation range defines the second part of the screen of the display unit 13, and the first part is automatically defined by the rest of the second part. If the modulation range is set to the non-active application windows without setting the number of the excluded non-active application windows, only the active application window is included in the first part, and all the non-active application windows are included in the second part. When the modulation range is set to the non-active application windows and the number of the excluded non-active application windows is set to 1, the active application window and the most recently selected non-active application window are included in the first part, and the remaining non-active application windows are included in the second part.

According to an exemplary implementation, the control unit 11 generates a frame image consisting of the video data for the first part and the second part and displays the frame data on the screen of the display unit 13 (S223).

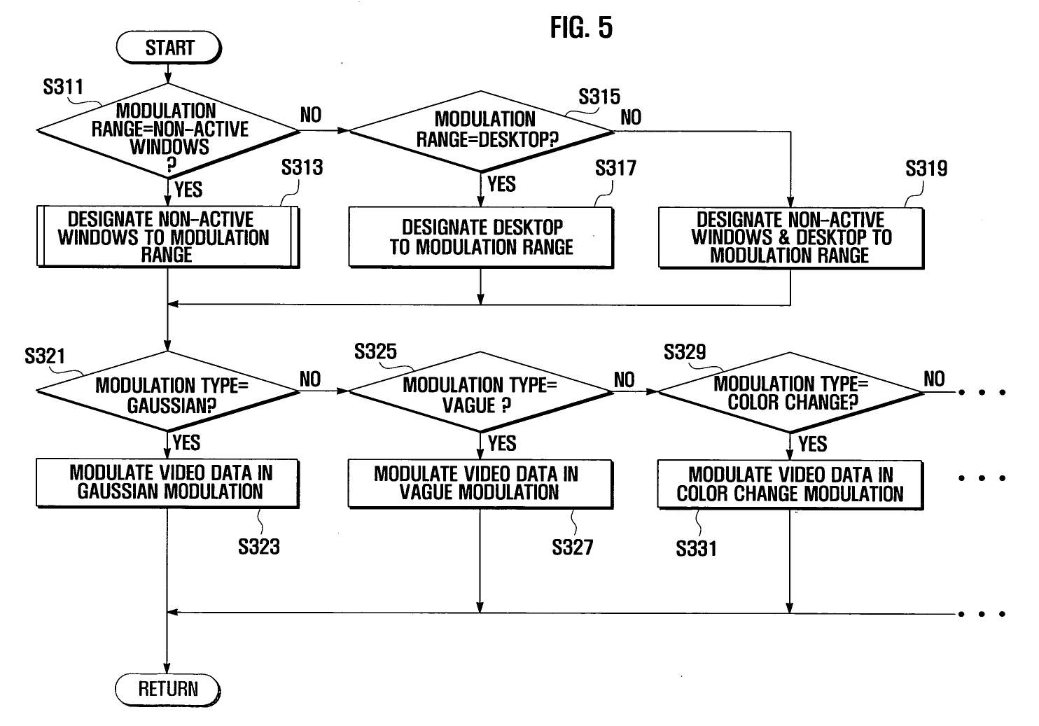

FIG. 5 is a flowchart illustrating a modulation procedure of the application window display method of FIG. 4.

Referring to FIG. 5, the control unit 11 determines whether the modulation range is set for the non-active application windows (S311). If the modulation range is set for the non-active application windows, the control unit 11 designates the video data corresponding to the non-active application windows for the modulation range (S313). The second part presents the video data of the non-active application program windows excluding a certain non-active application window.

If the modulation range is not set for the non-active application windows, the control unit 11 determines whether the modulation range is set for the desktop (S315). If the modulation range is set for the desktop, the control unit 11 designates the video data corresponding to the desktop image for the modulation range (S317). According to an exemplary implementation, the second part presents the video data of the desktop image.

If the modulation range is not set for the desktop, the control unit 11 designates the video data corresponding to the non-active application windows excluding a certain non-active application window and the desktop image for the modulation range (S319) such that the second part presents the video data of the non-active application windows excluding the non-active application window and the desktop image. The modulation is performed on the video data corresponding to the second part except for the area occupied by the active application windows.

After the modulation range is determined, the control unit 11 determines whether the modulation type is set to “Gaussian” (S321). If the modulation type is set to “Gaussian”, the control unit 11 modulates the video data corresponding to the second part in the Gaussian modulation scheme (S323). In the Gaussian modulation scheme, the video data of the second part is mixed with Gaussian data as noise data.

If the modulation type is not set to “Gaussian”, the control unit 11 determines whether the modulation type is set to “Vague” (S325). If the modulation type is set to “Vague”, the control unit 11 modulates the video data corresponding to the second part in a “Vague” modulation scheme (S327). The Vague modulation is performed by mixing or replacing the video data of the second part with specific video data.

If the modulation type is not set to “Vague”, the control unit 11 determines whether the modulation type is set to “Color Change” (S329). If the modulation type is set to “Color Change”, the control unit 11 modulates the video data corresponding to the second part such that the color of the second part is changed (S331). The Color Change modulation is performed by mixing or replacing the video data of the second part with auxiliary data for a specific color. If the modulation type is not set to “Color Change”, the control unit 11 modulates the video data corresponding to the second part in a predetermined modulation scheme.

FIGS. 8 to 10 are examples of screen images illustrating an application window display method according to an exemplary embodiment of the present invention. FIGS. 8 to 10 illustrate an application window display method in which a modulation range is set to the “non-active application windows and desktop.”

Referring to FIG. 8, the video data of the “non-active application windows and desktop” except for the active application window 63 relating to the current task are modulated in the Gaussian, Vague, or Color Change modulation scheme. According to an exemplary implementation, the control unit 11 modulates the video data of the non-active application windows 65 and of the desktop image that are not overlapped by the active application window 63, and displays the modulated video data on a screen 71.

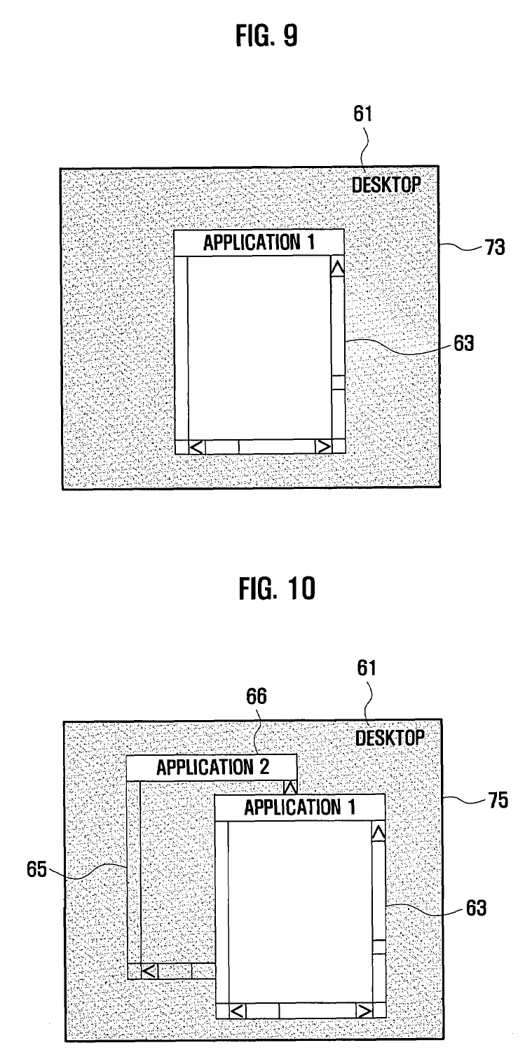

When a single application window 63 is open as shown in FIG. 9, the control unit 11 modulates the video data of the desktop 61 that is not overlapped by the active application window 63 and displays the modulated video data on a screen 73. According to the modulation result, alphanumeric characters and patterns disappear, become vague, or change to a preset color such that the active application window 63 is vividly highlighted. Since only the active application window 63 is highlighted, clutter caused by the non-active application windows and the desktop image is reduced.

When two or more application windows are opened and one of the open windows is the active application window 63 as illustrated in FIG. 10, a title bar 66 of the non-active application window 65 can be activated. That is, the title bar 66 of the non-active application window 65 is not modulated for the second part on the screen 75. Since the title bar 66 is activated even when the non-active application window 65 is modulated to disappear or to be vague, the user can easily select a target application window. Title bars of all non-active application windows can be excluded from the modulation.

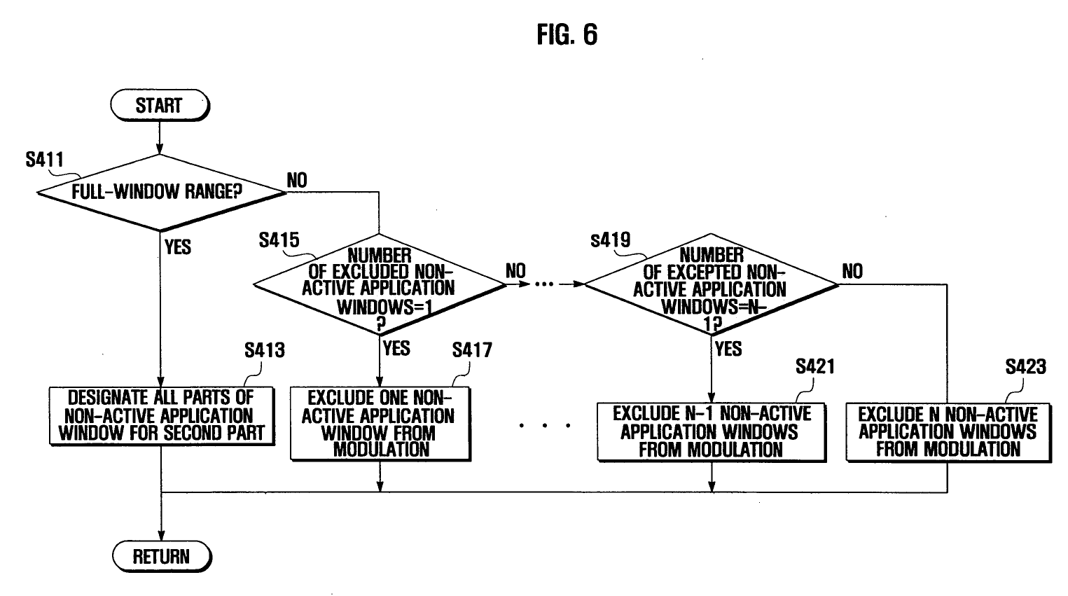

FIG. 6 is a flowchart illustrating a procedure for setting a modulation range of a non-active application window in the application window display method according to an exemplary embodiment of the present invention.

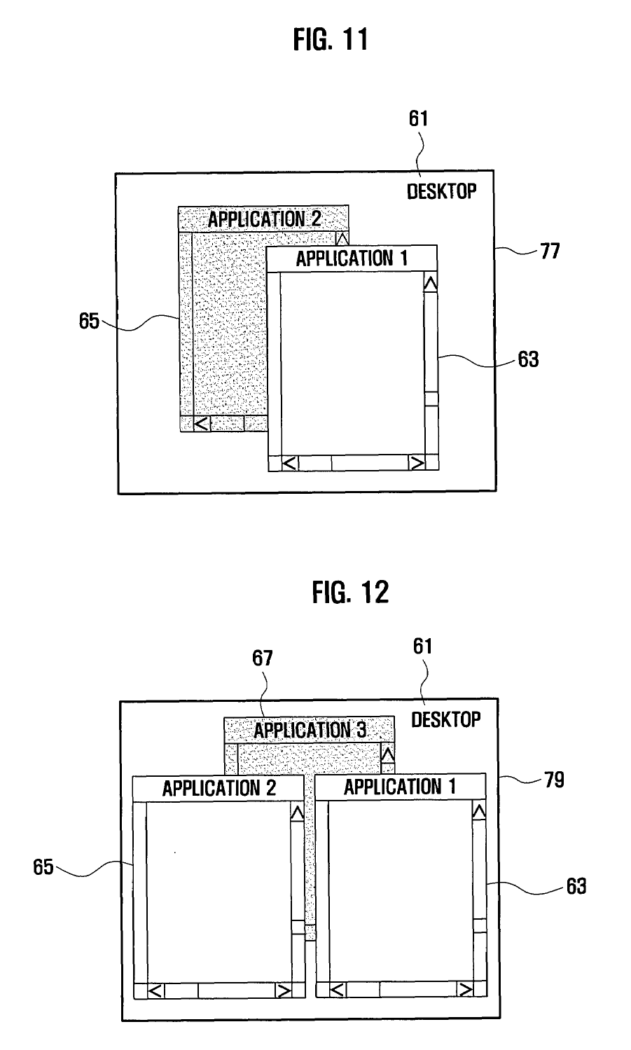

Referring to FIG. 6, the control unit 11 determines whether the modulation range of the non-active application window is set to a full-window range (S411). If the modulation range of the non-active application window is set to a full-window range, the control unit 11 designates all parts of the non-active application window for the second part to be modulated (S413). According to an exemplary implementation, only the active application window belongs to the first part and the rest of the non-active application window belongs to the second part. After the modulation of the second part is completed, the control unit 11 displays on a screen 77 the non-active application window 65 as a vague background of the active application window 63 as illustrated in FIG. 11. The modulation of the non-active application windows gives an effect of highlighting the active application window which allows a user to focus their attention.

If the modulation range of the non-active application window is not set to a full-window range, the control unit 11 determines whether a number of excluded non-active application windows is set to 1 (S415). If a number of excluded non-active application windows is set to 1, the control unit 11 excludes a most recently selected non-active application window and modulates the remaining non-active application windows (S417). According to an exemplary implementation, the active application window and the most recently selected non-active application window become the first part and the remaining non-active application windows become the second part.

If the number of the excluded non-active application windows is not set to 1, the control unit 11 increases the number until the number becomes n−1 to determine the preset number of the excluded non-active application windows (S419). If the number of the excluded non-active application windows is set to n−1, the control unit 11 excludes n−1 non-active application windows from modulation and modulates the remaining non-active application windows (S421). According to an exemplary implementation, the active application window and n−1 non-active application windows become the first part, and the remained non-active application windows become the second part. If the number of the excluded non-active application windows is not n−1, the control unit 11 excludes n non-active application windows from the modulation and modulates the remaining non-active application windows (S423).

After the modulation of the second part, all windows and the desktop image disappear or become vague except for the active application windows 63 and 65 and the non-active application window 67 excluded from the modulation. This application window display method, as illustrated in FIG. 12 which shows exemplary display on screen 79, is used when data displayed on the non-active application window is required for reference while working with the active application window. This application window display method can be adopted when the modulation range is set to “non-active application windows and desktop.”

As described above, the application window display method of an exemplary embodiment of the present invention facilitates modulation of video data for unimportant image objects such as non-active application windows and a desktop image such that only important image objects such as an active application window and other preset objects are prominently displayed, thereby allowing users to concentrate their attention on a current task. Also, the application window display method of an exemplary embodiment of the present invention can modulate the video data for the non-active application windows and desktop in various manners except for one or more interesting active application windows. This facilitates a user's ability to focus on a current task.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for displaying application windows on a display screen comprising:
modulating video data corresponding to a non-active part of a display screen using auxiliary data;
displaying the modulated video data in the non-active part on the display screen.

2. The method of claim 1, wherein the modulating of the video data comprises mixing the video data with the auxiliary data.

3. The method of claim 1, wherein the auxiliary data comprises Gaussian data.

4. The method of claim 1, wherein the modulating of the video data comprises replacing the video data with the auxiliary data.

5. The method of claim 4, wherein the auxiliary data comprises color change data for changing a color of the non-active part.

6. The method of claim 1, wherein the auxiliary data comprises vague modulation data for making the non-active part vague.

7. The method of claim 1, wherein the non-active part comprises at least one of non-active application windows and a desktop image.

8. The method of claim 1, wherein the non-active part comprises at least one of non-active application windows and a desktop image without title bars of the non-active application windows.

9. The method of claim 1 further comprising setting at least one of a modulation range and a modulation level.

10. The method of claim 9, wherein the modulating of the video data comprises:
verifying the modulation range; and
modulating the video data corresponding to the modulation range.

11. The method of claim 1, wherein the modulating of the video data comprises:
detecting a selection of an application window;
determining whether the selected application window is open in a window mode;
processing the video data corresponding to the selected application window to display as a top-most window if the selected application window is open in a window mode; and
modulating the video data except for the video data of the selected application window.

12. The method of claim 1, wherein the modulating of the video data comprises:
determining a number of application windows for an active part of the display screen;
selecting the determined number of application windows in an order of recent selection;
designating the selected application windows to the active part; and
designating application windows that are not selected to the non-active part.

13. A computer system comprising:
a display unit for displaying images represented by information on the operation of the computer system;
a video data generation unit for generating video data for at least one of an active part and a non-active part of a screen of the display unit; a monitoring unit for monitoring signals related to the active and non-active parts of the screen of the display unit and variations of the signals; and
a video data modulation unit for modulating video data corresponding to the non-active part of the screen of the display unit using auxiliary data.

14. The computer system of claim 13, wherein the display unit displays images represented by information on the operation of the computer system on the basis of video signals from the video data generation unit.

15. The computer system of claim 13, wherein the non-active part comprises at least one of non-active application windows and a desktop image.

16. The computer system of claim 13, wherein the non-active part comprises at least one of non-active application windows and a desktop image without title bars of the non-active application windows.

17. The method of claim 1, further comprising dividing the display screen into the active and the non-active parts before the modulating.
